(19) United States
(12) Patent Application Publication
(10) Pub. No.: US 2012/0249835 A1
(43) Pub. Date: Oct. 4, 2012

(54) Image Acquiring System and Driving Method for Camera Module

(75) Inventor: Yi-Chang Yang, Taipei (TW)

(73) Assignee: PEGATRON CORPORATION, Taipei (TW)

(21) Appl. No.: 13/427,961

(22) Filed: Mar. 23, 2012

(30) Foreign Application Priority Data
Mar. 28, 2011 (TW) 100110636

(51) Int. Cl. H04N 5/76; H04N 5/225

(52) U.S. Cl. 348/231.99; 348/374; 348/E05.024

(57) ABSTRACT

An image acquiring system including a camera module and a host is provided. The camera module for acquiring images includes a control unit and a first connector. The host includes a driver unit and a second connector. The driver unit is coupled to the second connector and stores an initializing data for initialize the camera module; and the second connector is adapted to be connected with the first connector. The set of initializing data is transferred from the second connector to the first connector when the second connector is coupled to the first connector, and the initializing data is then transferred to the control unit. A driving method of camera module for driving a camera module without any memory element is also described.

### CROSS-REFERENCES TO RELATED APPLICATIONS

This non-provisional application claims priority under 35 U.S.C. §119(a) on Patent Application No. 100110636 filed in Taiwan, R.O.C. on 2011 Mar. 28, the entire contents of which are hereby incorporated by reference.

### BACKGROUND

1. Technical Field

The disclosure relates to an image acquiring system and a driving method for a camera module, and in particular to an image acquiring system with a camera module that does not include any memory element, and to a driving method of the camera module.

2. Related Art

Nowadays, mobile electronic devices, such as notebook computers or tablet computers, are implemented with internal camera modules for the user to take photos, record videos or make a video call at any time.

Please refer to FIG. 1, which is a systematic block diagram of a conventional image acquiring system with a host 11 and a camera module 12. Camera module 12 mainly includes a light-sensing element 121, a control unit 122, a first connector 123 (ex. USB client) and a memory element 124. Host 11 includes a driving unit 111 and a second connector 112 (USB controller). The external light passes through the lens and then focuses and images on light-sensing element 121. The control unit 122 further encodes the light signals sensed by light-sensing element 121 into image signals.

Since the initializing data for every camera module 12 is different, the conventional camera module 12 usually includes the essential initializing data stored in memory element 124 in advance; the aforesaid memory element may be EEPROM (Electrically-Erasable Programmable Read-Only Memory), Flash Memory, etc. Thus, when camera module 12 is connected to host 11, control unit 122 may directly access memory element 124 to retrieve the initializing data required for initialization processes, thereby enabling the data transmission between host 11 and camera module 12.

### SUMMARY

Accordingly, in an embodiment of the disclosure, an image acquiring system includes a camera module and a host. The camera module has a control unit and a first connector; the control unit is connected electrically with the first connector. The host has a driving unit and a second connector. The driving unit is connected electrically with the second connector and stores a set of initializing data for driving the camera module; the second connector is connectable with the first connector. When the driving unit drives the camera module, the initializing data is sent through the second connector to the first connector, and then sent from the first connector to the control unit.

Different from the conventional technology that requires the initializing data stored in the memory element of the camera module to activate the camera module, the image acquiring system according to the disclosure drives the camera module through the initializing data pre-stored in the driving unit of the host. Additionally, the initializing data are different for various camera modules. Since the camera module and the correspondingly installed host are assigned for system assembly manufacturers in advance, the initializing data are able to be pre-stored in the correspondingly installed driving unit of the host. When the first connector of the camera module and the second connector of the host are coupled with each other, once a user activates the camera module, the initializing data stored in the driving unit are able to be sent through the second connector, the first connector to the control unit.

Therefore, the image acquiring system according to the disclosure does not require any extra memory element stored on the camera module to store the initializing data for activation process, which further effectively reduces the manufacturing cost of the camera module.

In another embodiment, a method is provided for driving a camera module. The method includes: connecting the first connector and the second connector; the driving unit sending the initializing data through the second connector to the first connector; sending the initializing data from the first connector to the control unit; and driving the camera module.

Different from the conventional technology that requires the initializing data stored in the memory element of the camera module to activate the camera module, the driving method for camera module according to the disclosure drives the camera module through the initializing data pre-stored in the driving unit of the host. Additionally, the initializing data are different for various camera modules. Since the camera module and the correspondingly installed host are assigned for system assembly manufacturers in advance, the initializing data are able to be pre-stored in the correspondingly installed driving unit of the host. Therefore, the driving method according to the disclosure does not require any extra memory element stored on the camera module to store the initializing data for activation process, which further effectively reduces the manufacturing cost of the camera module.

In short, the disclose reduces the component amounts of the camera module without affecting any original function thereof, thereby reducing the manufacturing cost of the camera module, as well as the manufacturing cost of notebook and tablet computers.

### BRIEF DESCRIPTION OF THE DRAWINGS

The disclosure will become more fully understood from the detailed description given below for illustration only, and thus not limitative of the disclosure, wherein:

FIG. 1A is a system block diagram of a conventional image acquiring system;

FIG. 2 is a system block diagram of an image acquiring system according to a first embodiment;

FIG. 3 is a system block diagram of another image acquiring system according to a second embodiment;

FIG. 4 is a flow chart of a driving method for a camera module according to a third embodiment; and

FIG. 5 is a flow chart of another driving method for a camera module according to a fourth embodiment.

### DETAILED DESCRIPTION

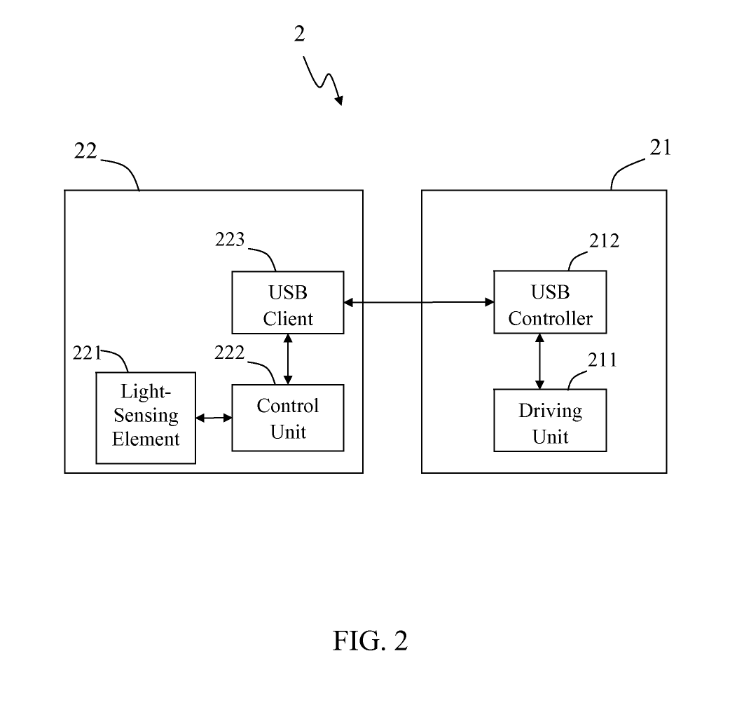

Please refer to FIG. 2, which is a system block diagram of an image acquiring system according to a first embodiment. Image acquiring system 2 includes a host 21 and a camera module 22. Camera module 22 is adapted to acquire images and includes light-sensing element 221, control unit 222 and a first connector 223 (ex. USB Client); wherein control unit 222 is connected electrically to light-sensing element 221 and first connector 223. Host 21 mainly includes a driving unit 211 and a second connector 212; wherein driving unit 211 is connected electrically to second connector 212 (ex. USB Host), and driving unit 211 stores a set of initializing data. When driving unit 211 of host 21 is controlled to initialize camera module 22, the initializing data are sent by connecting second connector 212 with first connector 223 to send to first connector 223, and then sent via first connector 223 to control unit 222.

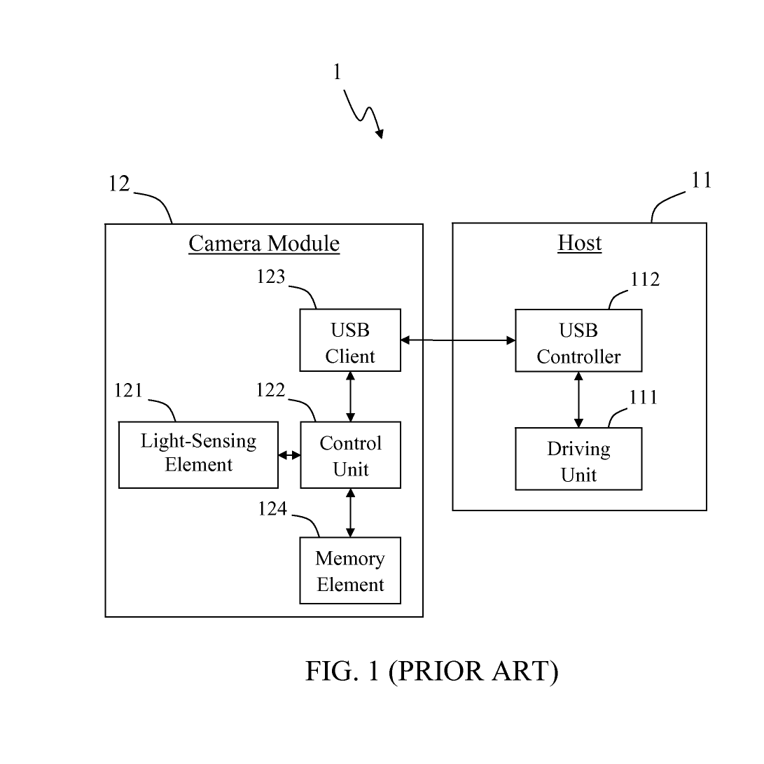

Comparing to the conventional technology that stores the initializing data in memory element 124 of camera module 12 (see FIG. 1), in the present embodiment image acquiring system 2 stores initializing data at driving unit 211 of host 21. Additionally, the initializing data 22 are different for various camera modules. Since for system assembly manufacturers, the camera module 22 and the correspondingly installed host 21 are assigned in advance, the initializing data are able to be pre-stored in the correspondingly installed driving unit 211 of host 21. The first connector of camera module is adapted to electrically connectable to second connector. When the camera module 22 is activated, the initializing data stored in driving unit 211 are sent through second connector 212, first connector 223 to control unit 222.

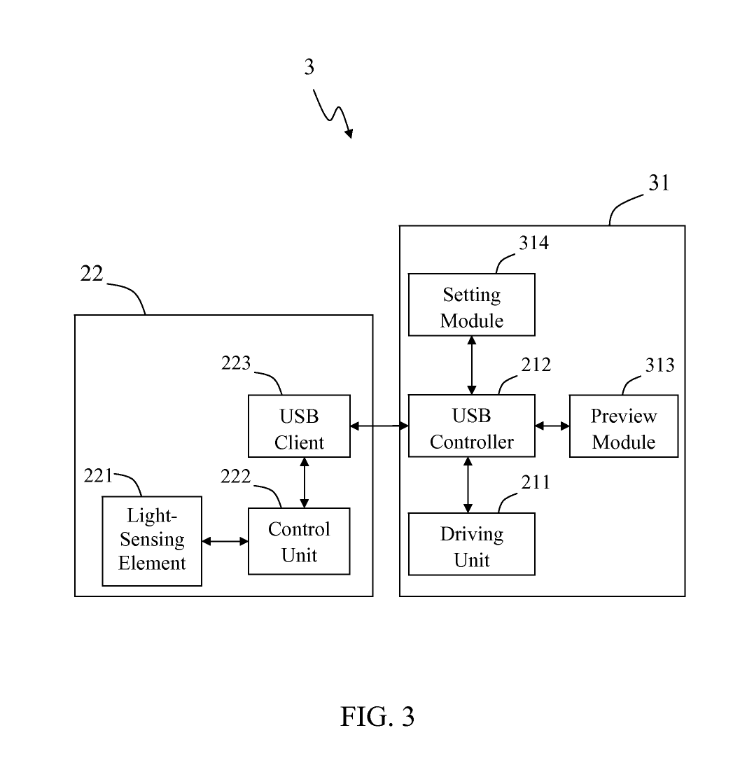

Please further to FIG. 3, which is a system block diagram of another image acquiring system according to a second embodiment. In comparison with the first embodiment above, host 31 in the present embodiment further include a preview module 313, adapted to preview the image acquired by camera module 22. In addition, host 31 in the present embodiment further include a setting module 314, adapted to provide image quality parameter(s) according to the acquired or previewed image; the image quality parameter(s) is sent through second connector 212, first connector 223 to control unit 222. Thus, control unit 222 may set up the acquired image with a superior quality according to the image quality parameter(s).

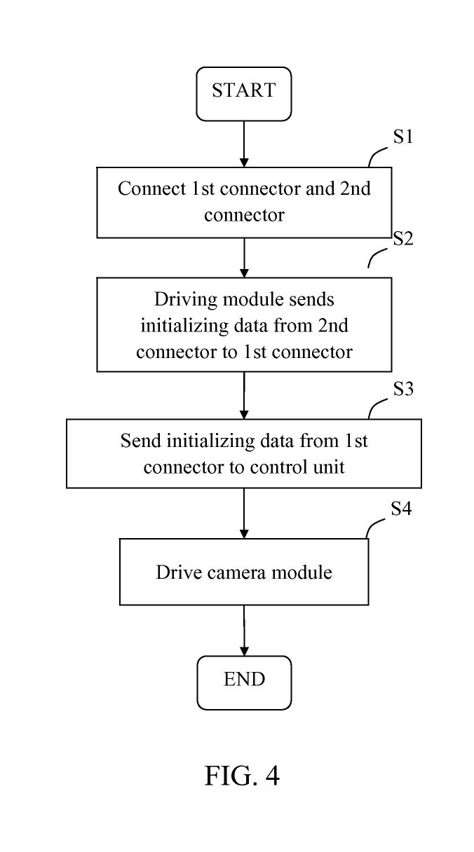

Please refer to FIG. 4, which is a flow chart of a driving method for a camera module according to a third embodiment. The steps of the flow chart are respectively described as follows.

Step S1: Connect a first connector and a second connector.

In this Step, the host includes a driving unit and a second connector; wherein the driving unit is connected electrically with the second connector. The camera module includes a control unit, a light-sensing element and a first connector. The control unit is connected electrically with the light-sensing element and the first connector. Therefore Step S1 of the driving method for camera module according to an embodiment is to connect the first connector of the camera module to the second connector of the host.

Step S2: Driving module sends initializing data from 2nd connector to 1st connector.

The initializing data that the camera module requires for activation is stored in the driving unit of the host. After accessed by the control unit, the initializing data are sent through the second connector to the first connector. The driving unit of the host may be realized by a hardware and software group including a central processing unit, a system memory and an operation system.

Step S3: Send initializing data from 1st connector to control unit.

Further send the initializing data through the first connector to the control unit. Step S4: Drive camera module.

When the control unit receives and executes the initializing data, the camera module is able to be driven by the host.

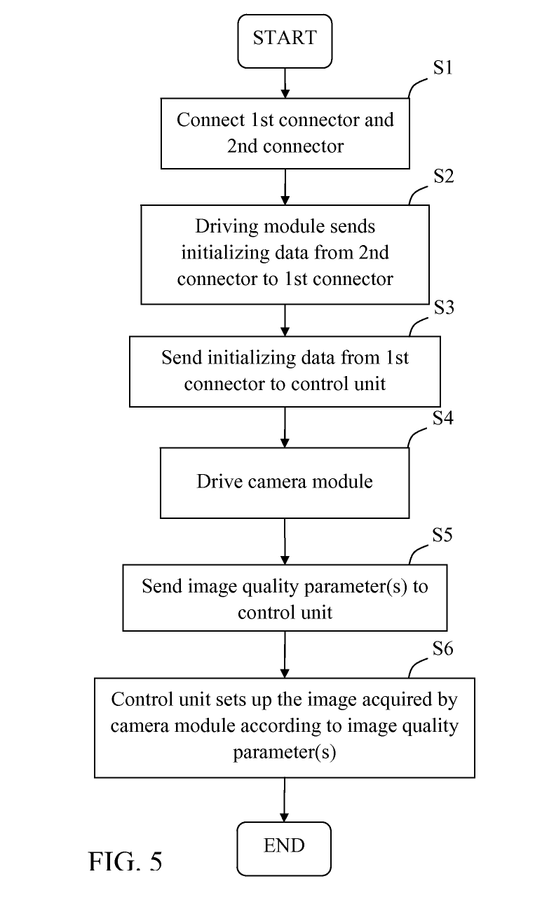

Please refer to FIG. 5, which is a flow chart of another driving method for a camera module according to a fourth embodiment. In comparison with the third embodiment, the driving method further includes Steps S5 and S6 after Step S4.

Step S5: Send image quality parameter(s) to control unit.

The present Step S5 is to preview the image acquired by the camera module on the host, further determine the image quality, and then sent image quality parameter(s) pre-stored on the host through the first connector and the second connector to the control unit of the camera module.

Step S6: Control unit sets up the image acquired by the camera module according to the image quality parameter(s).

After receiving the image quality parameter(s), the control unit of the camera module is able to set up and acquire images with superior quality.

The third and fourth embodiments are both adapted to drive camera modules without any memory element; the memory element may be EEPROM (Electrically-Erasable Programmable Read-Only Memory), or Flash Memory.

In comparison with the conventional technology that requires the initializing data stored in the memory element of the camera module to activate the camera module, the driving method for camera module according to the above embodiments drives the camera module through the initializing data pre-stored in the driving unit of the host. Additionally, the initializing data are different for various camera modules. Since for system assembly manufacturers, the camera module and the correspondingly installed host are assigned in advance, the initializing data are able to be pre-stored in the correspondingly installed driving unit of the host. Specifically, the camera module does not need any embedded memory element, thus reducing the manufacturing cost of the camera module. What needs to be emphasized specifically is, the system and method provided in above embodiments may not be applicable to those general, external, and standalone camera module available in the consumer markets, since the driving unit of the host is not able to provide the corresponding initializing data for activation.

While the disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An image acquiring system, comprising:
a camera module, having a control unit and a first connector, the control unit being connected electrically with the first connector ; and
a host, having a driving unit and a second connector, the driving unit being connected electrically with the second connector and storing a set of initializing data for driving the camera module, and the second connector being connectable with the first connector;
wherein when the driving unit drives the camera module, the initializing data is sent through the second connector to the first connector, and then sent from the first connector to the control unit.

2. The image acquiring system according to claim 1, wherein the host further comprises a preview module to preview an image acquired by the camera module.

3. The image acquiring system according to claim 2, wherein the host further comprises a setting module to provide at least an image quality parameter, the image quality parameter being sent through the second connector, the first connector to the control unit of the camera module, thereby the control unit setting up the image according to the image quality parameter.

4. The image acquiring system according to claim 3, wherein the camera module is free of memory element, the memory element being EEPROM (Electrically-Erasable Programmable Read-Only Memory), or Flash Memory.

5. A method applicable to a host for driving a camera module, the camera module having a control unit and a first connector, the host having a driving unit and a second connector, and the driving unit having a set of initializing data, the method comprising:
connecting the first connector and the second connector;
the driving unit sending the initializing data through the second connector to the first connector;
sending the initializing data from the first connector to the control unit; and
driving the camera module.

6. The method according to claim 5 further comprising:
sending at least an image quality parameter to the control unit; and
the control unit setting up an image acquired by the camera module according to the image quality parameter.

7. The method according to claim 6, wherein the camera module is free of any memory element.
